(19) United States
(12) Patent Application Publication
(10) Pub. No.: US 2019/0208760 A1
(43) Pub. Date: Jul. 11, 2019

(54) Solar Powered LED Fly Trap

(71) Applicant: KNESS MFG. CO., INC., ALBIA, IA (US)

(72) Inventor: DENNIS TOWNE, Warrensburg, MO (US)

(21) Appl. No.: 16/233,757

(22) Filed: Dec. 27, 2018

Related U.S. Application Data
(60) Provisional application No. 62/613,836, filed on Jan. 5, 2018.

(51) Int. Cl. A01M 1/04; F21S 9/03; F21V 23/04

(52) U.S. Cl. CPC A01M 1/04; F21Y 2115/10; F21V 23/04; F21S 9/037

(57) ABSTRACT

A fly trap having a base with an insect trapping substance, a shroud removably attached to the base, and a light module coupled to the shroud. The light module has a solar panel, a battery, a switch with on and off positions, and at least one LED. The LED is located on a PCB and is directed toward the insect trapping substance.

### CROSS-REFERENCE TO RELATED APPLICATION(S)

This application claims priority to U.S. Provisional Patent Application Ser. No. 62/613,836, filed on Jan. 5, 2018, entitled “Solar Powered LED Fly Trap,” the complete disclosure of which is hereby incorporated herein by reference in its entirety.

### SUMMARY OF THE PRESENT INVENTION

One aspect of the present invention includes a fly trap having a base with an insect trapping substance, a shroud removably attached to the base, and a light module coupled to the shroud. The light module has a solar panel, a battery, a switch with on and off positions, and at least one LED. The LED is located on a PCB and is directed toward the insect trapping substance.

### BRIEF DESCRIPTION OF THE DRAWINGS

In the drawings:

FIG. 1 is a perspective view of a fly trap of an embodiment of the present invention.

FIG. 2 is an exploded view of a fly trap of an embodiment of the present invention.

FIG. 3 is a top view of a fly trap of an embodiment of the present invention.

FIG. 4 is a front view of a fly trap of an embodiment of the present invention.

FIG. 5 is a side view of a fly trap of an embodiment of the present invention.

FIG. 6A is a view of the attachment slots on the base of an embodiment of the present invention.

FIG. 6B is a view of the attachment slots on the base of another embodiment of the present invention.

FIG. 6C is a view of the attachment slots on the base of another embodiment of the present invention.

### DETAILED DESCRIPTION OF EMBODIMENTS

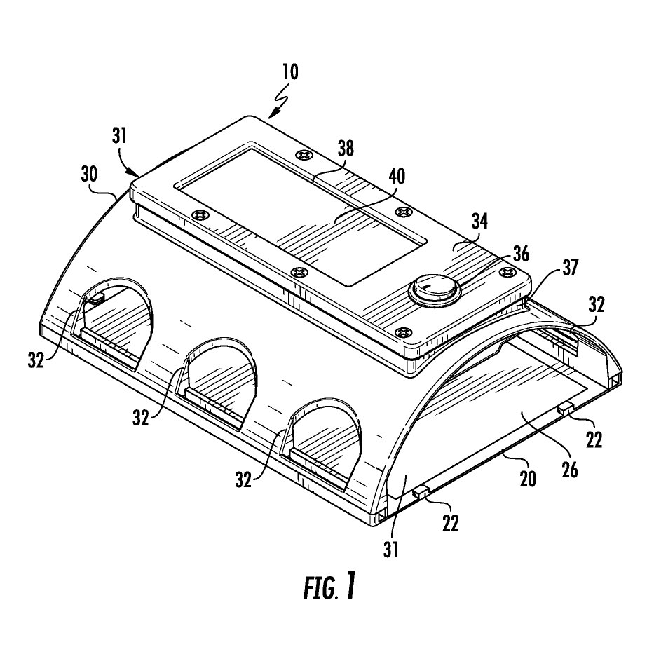

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, an insect trap 10 is shown in its assembled state. The insect trap 10 has a base 20 and a shroud 30, which is slideably attached to the base 20. The base 20 has an insect trapping substance 26 disposed on one side. The insect trapping substance may be a generic fly paper, as is known in the art. The substance 26 may also include any other material that is able to be attached to the base 20 in any manner known in the art, such as a liquid that may be contained on base 20. As shown, the fly paper 26 may be removeably attached to the base 20 and held in place by a number of fly paper tabs 22. The fly paper tabs 22, as shown, may include two tabs on either end of the base 20. However, these tabs may be located in any variation of configuration on the base 20 as would hold the fly paper 26 in place. This tab configuration is advantageous because no adhesive is required on the fly paper which makes for easy removal and replacement of the fly paper 26, however, it is also contemplated that an adhesive-backed fly paper may also be used. The adhesive may be such that it is easily removed from the base 20 and may be such that it leaves minimal residue on the base 20.

The shroud 30 further includes a substantially semi-circular opening 31 on either end. The shroud 30 may also include at least one side opening 32. As shown in FIG. 1, the shroud 30 may have six side openings 32 configured as three on either side of the shroud 30. It should be known that these openings may be placed in any manner convenient to the design of the shroud, including a single opening that spans substantially the length of shroud 30, or any other combination.

The shroud 30 may further include a light module. The light module may include a solar array 40 disposed toward the outside of the shroud 30 facing away from base 20. The light module may further comprise a switch 36 that may be disposed in any location that is convenient for a user to easily activate and deactivate the switch 36. The light module further comprises a cover 34 which may provide an aesthetically pleasing outward appearance of the light module, and may also provide structural support for the light module.

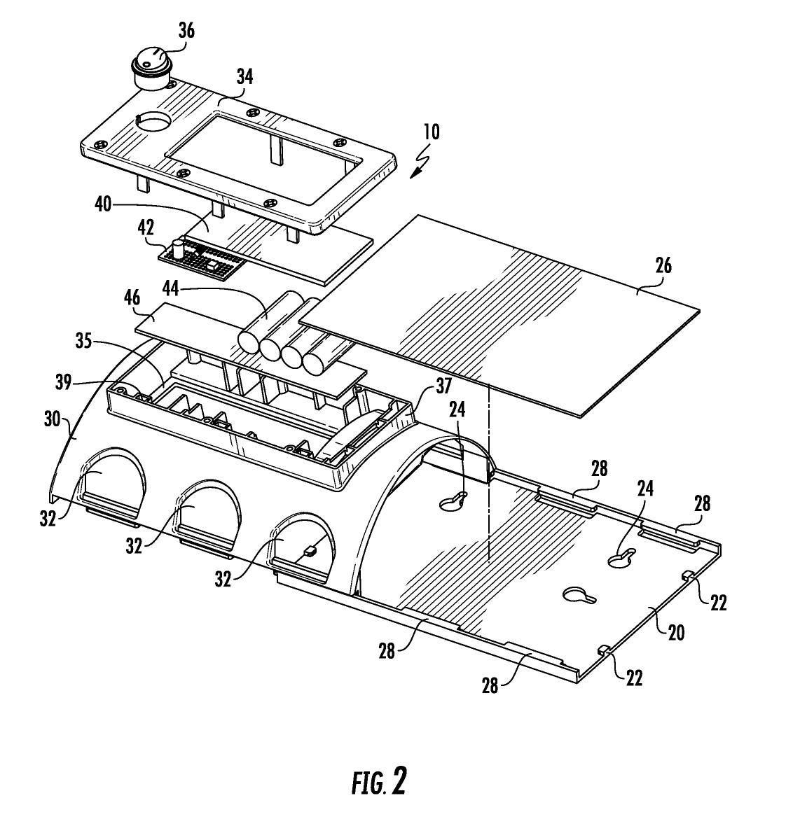

FIG. 2 shows an exploded view of all of the elements of the base 20, the shroud 30, and the light module. The base 20 may further comprise shroud tabs 28, which provide support for the shroud 30 as it is slideably installed onto the base 20. The tabs 28, as shown, are three on either side of the base 20, although there may be more or less tabs as the design may require. The base 20 may further include keyhole slots 24, which provide for convenient attachment to a post, a beam, or any other attachment surface a user may require. The insect trapping substance 26 is again shown as fly paper, and may be attached via the fly paper tabs 22.

The shroud 30 may further include base tabs 31 corresponding to the shroud tabs 28 on the base, that interact with the shroud tabs 28 to hold the shroud in place when the shroud 30 is installed onto the base 20. These tabs provide enough resistance to movement such that the shroud may stay in place vertically when installed, but allow for a user to easily slide the shroud away from the base when a user deems necessary. The shroud may also include a light module receiving portion 37. The light module receiving portion 37 may have a shape that corresponds to the lighting module, and may also include a ledge 35 to support a light emitting diode (LED) printed control board (PCB). The light module receiving portion 37 may also include a window 39 through which LEDs disposed on the LED PCB may shine through and down to the insect trap substance 26. It should also be known that the light source may be any other light source known in the art.

The lighting module may include an LED PCB 46, which comprises at least one LED, and is configured to shine down through the window 39 of the light module receiving portion 37. A rechargeable battery 44 may be located above the LED PCB 46, and an electrical connection with the LED PCB 46 providing power to the LEDs. A control PCB 42 an electrical connection with a switch 36 may be disposed between the rechargeable batteries 44 and the LED PCB 46. A solar array 40 may be disposed above the rechargeable batteries 44 and within a window of the light module cover 34 such that it is exposed to ambient light when the shroud 30 is in the installed position on the base 20.

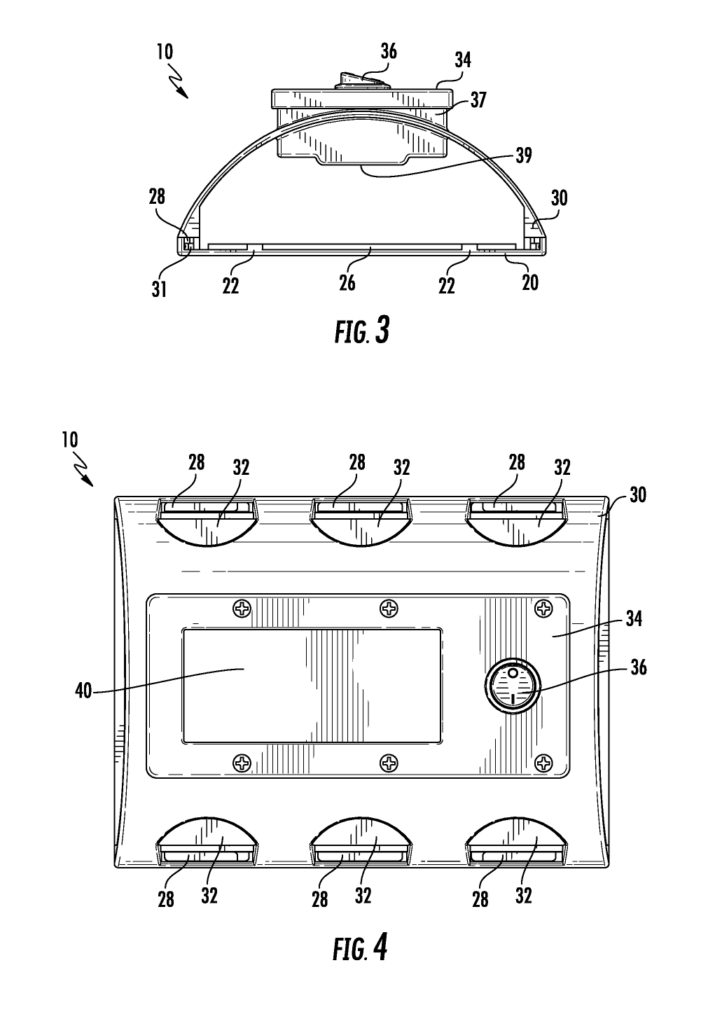

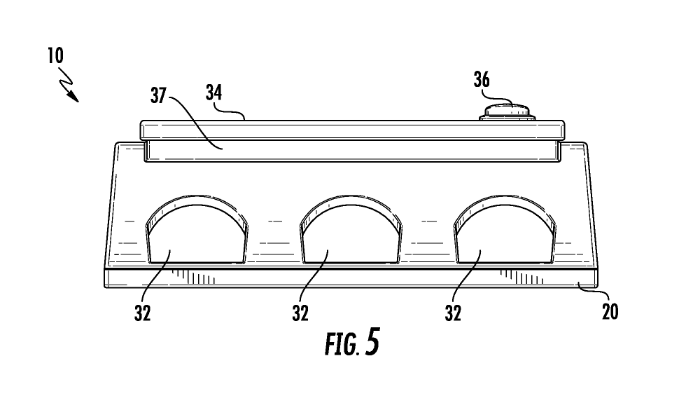

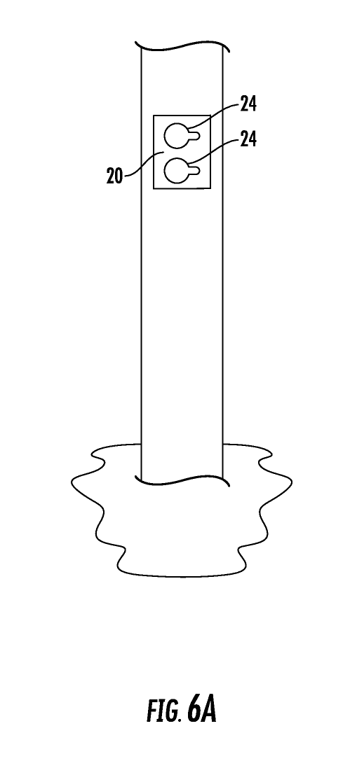

FIGS. 3-5 show the insect trap in its three orthogonal directions. FIG. 3 shows a top view of the trap when installed in a substantially vertical orientation. FIG. 4 shows a front view of the trap installed in a vertical orientation. FIG. 5 shows a side view of the trap when installed in a vertical orientation.

Referring back to FIG. 1, the trap 10 and the shroud 30 are shown in their installed position. In operation, the solar array 40 is exposed to ambient light and converts the light into electrical energy, in a way known in the art, which may then be stored in the rechargeable batteries 44. When a user would like to utilize the trap the switch 36, which has an “ON” position and an “OFF” position, is switched to the “ON” position. The switch 36 is electrically connected to the control PCB, and when the switch is in the “ON” position the control PCB completes an electrical circuit between the rechargeable batteries and the LED PCB, which in turn provides power to the LED or LEDs. With power supplied to the LED, the light generated by the LED may then be shone in a downward direction, as shown in FIG. 1, and onto the insect trapping substance 26. The insect trapping substance 26 is generally of a color that is attractive to the type of insect that the user would like to trap. When the light is shone onto the fly paper providing an attractive and bright color, insects may fly through end openings 31 or side openings 32 toward the insect trapping substance 26, eventually coming into contact with the substance 26. The insect trapping substance 26 is sticky enough such that once the insects come into contact with the substance 26 they are stuck to the paper and unable to escape.

By using the solar array 40 and the rechargeable battery 44, this light may be provided at all times of day, including at night, without using any external electrical connectors. This is also accomplished without using any external power devices or recharging devices. Once the insect trapping substance 26 is used up, is no longer effective, or is too full to be effective anymore, it may be easily replaced. The shroud 30 may be slid off of the base 20 in a manner shown in FIG. 2. The removal may also be a snap fit that may be easily un-snapped to remove the shroud 30 from base 20. The shroud 30 may either be completely removed from the base 20 or may be removed to a point where retrieval of the insect trapping substance 26 is easily achieved. In the case of fly paper with no adhesive on its back, this is simply done by sliding the fly paper 26 out of the fly paper tabs 22 on the base 20, and removing the fly paper. In this fashion, a new sheet of fly paper 26 may be just as easily installed by placing the new sheet of fly paper 26 back into the tabs 22 on the base 20.

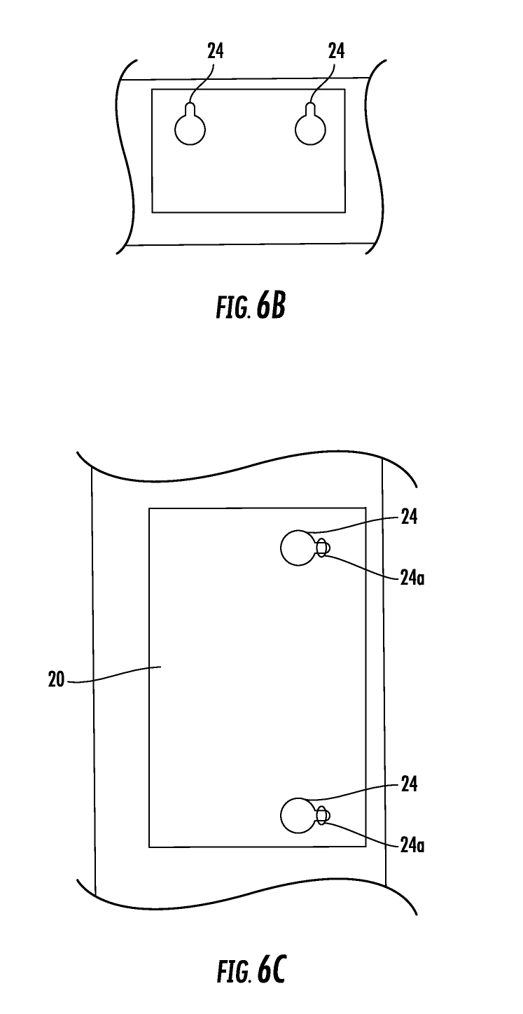

One advantage of the design, as shown in FIGS. 1-5, is that the insect trapping substance 26 does not need to be in a substantially horizontal position. By substantially horizontal position, it is meant that if a liquid insect trapping substance 26 was used, it would not spill over or out of the base 20. By using the design as shown, the trap 10 may be placed in a substantially vertical position, with the base 20 substantially on a plane parallel with the direction of gravity. FIGS. 6A-6C describe two different orientations which are both considered vertical. A screw may be placed in a post or a beam and the base 20 may be placed over the screws through the keyhole slots 24. Note that the keyhole slots may be larger or smaller than shown in the figure, which are shown large for illustrative purposes. The keyhole slots have a wide portion through which a screw head 24a may fit through, and a skinny portion, which the main body of a screw may fit through, but the screw head 24a cannot. In this fashion, the base 20 and, in turn, the trap 10, may be easily moved from location to location.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A fly trap comprising:
a base having an insect trapping substance;
a shroud removably attached to the base; and
a light module coupled to the shroud, the light module comprising:
a battery;
a solar panel electrically connected to the battery;
a switch with an on position and an off position; and
at least one light emitting diode (LED) disposed on a LED printed circuit board (PCB) and directed toward the insect trapping substance;
wherein when the switch is in the on position, the LED is electrically connected to the battery.

2. The fly trap of claim 1, wherein when the switch is in the off position, the LED is electrically isolated from the battery.

3. The fly trap of claim 1, wherein the shroud is slidably removable from the base and is removable without the use of tools.

4. The fly trap of claim 1, further comprising a control PCB.

5. The fly trap of claim 4, wherein the control PCB is electrically connected to the switch.

6. The fly trap of claim 1, wherein the solar panel comprises a solar array that faces a source of ambient light.

7. The fly trap of claim 1, wherein the shroud comprises an arcuate shape extending from a first side of the base to a second side of the base.

8. The fly trap of claim 7, wherein the shroud further comprises base tabs.

9. The fly trap of claim 8, wherein the base further comprises shroud tabs.

10. The fly trap of claim 9, wherein the shroud tabs and the base tabs correspond to one another such that the shroud is slidably removable.

11. The fly trap of claim 10, wherein the shroud tabs and the base tabs correspond to one another such that the shroud remains stationary with respect to the base when the fly trap is installed in a vertical orientation.

12. The fly trap of claim 1, further comprising a solar panel fascia removably attached to the shroud.

13. The fly trap of claim 12 wherein the solar panel fascia is configured to hold the solar panel in place.

14. The fly trap of claim 13 wherein the solar panel fascia is removable by hand and without the use of tools.

15. The fly trap of claim 1, wherein the base further comprises at least one keyhole slot.

16. The fly trap of claim 15, wherein the fly trap is functional in a substantially vertical orientation.

17. The fly trap of claim 1, wherein the battery is a rechargeable battery.

18. A battery powered LED fly trap comprising:
a base having a replaceable insect trapping substance;
a shroud slidably attached to the base and having a switch with an on position and an off position; and
a light module coupled to the shroud, the light module comprising:
a printed circuit board (PCB);
a battery electrically connected to the PCB;
a solar panel electrically connected to the battery and configured to recharge the battery; and
a light emitting diode (LED) disposed on the PCB and directed toward the insect trapping substance;
wherein when the switch is in the on position, the LED is electrically connected to the battery.

19. The battery powered LED fly trap of claim 18, further comprising a solar panel fascia removably attached to the shroud.

20. The battery powered LED fly trap of claim 18, wherein the solar panel faces a source of ambient light.
